(19) United States
(12) Patent Application Publication
(10) Pub. No.: US 2025/0349142 A1
(43) Pub. Date: Nov. 13, 2025

(54) SYSTEMS AND METHODS FOR ODOMETER MILEAGE EXTRACTION

(71) Applicant: American Family Mutual Insurance Company, S.I., Madison, WI (US)

(72) Inventors: Xiawei Guo, Union City, CA (US); Boahua Sun, Fremont, CA (US); Daniel A. Dickinson, Middleton, WI (US); Kevin S. Runde, Blue Mounds, WI (US)

(21) Appl. No.: 19/200,234

(22) Filed: May 6, 2025

Related U.S. Application Data
(60) Provisional application No. 63/643,605, filed on May 7, 2024.

(51) Int. Cl. G06V 30/146; G06V 10/20; G06V 10/82; G06V 20/59

(52) U.S. Cl. CPC G06V 30/147; G06V 10/20; G06V 10/82; G06V 20/59

(57) ABSTRACT

Systems and methods are provided for determining information, such as characters, from an image of a vehicle odometer using a trained character recognition object detection model. Methods and systems are included for training a character recognition object detection model to identify characters in the image of a vehicle odometer by repeatedly receiving an image, augmenting the image, identifying odometer character regions and characters, and comparing the identified odometer character regions and characters with those on annotated training images, and updating the model. Cloud-based and mobile application systems are provided for receiving an image from a user, using the trained character recognition object detection model to output odometer character regions and, for each character region, a class label and a probability, and using a post-processing application to determine the odometer mileage number based on the output of the trained character recognition object detection model.

### CROSS-REFERENCE TO RELATED APPLICATION

This application claims the benefit of U.S. Provisional Application No. 63/643,605 filed May 7, 2024, which is incorporated herein by reference in its entirety.

### TECHNICAL FIELD

This disclosure relates generally to systems and methods for machine learning object detection, and more specifically to systems and methods for machine learning character recognition.

### BACKGROUND

Obtaining information from a vehicle dashboard, such as the odometer mileage, is periodically done for a variety of purposes, e.g., vehicle maintenance, vehicle title transfer, to obtain insurance, and/or to submit insurance claims, among others. Depending on how frequently the information needed, it can be particularly helpful to streamline the information acquisition process.

By way of one example, an insurance company may prioritize suppling customers or users with an easy and streamlined way to provide all the information needed when reporting a claim or asking for an insurance quote. A simple, reliable, and efficient process for information acquisition or submission would improve the customer experience, reduces human error and accelerates the information collection process. An accurate mileage reading is a key piece of information that is relevant for auto insurance quotes and claims processing, among other processes. In some aspects the vehicle mileage can be combined with the License Plate number and/or the Vehicle Identification Number (VIN) to get an overview of the information needed for many insurance processes and workflows.

### BRIEF DESCRIPTION OF THE DRAWINGS

The above needs are at least partially met through provision of the System and Methods for Odometer Mileage Extraction described in the following detailed description, particularly when studied in conjunction with the drawings, wherein:

FIG. 1 comprises a flow chart of a method for odometer mileage extraction as configured in accordance with various embodiments of the invention;

FIG. 2 comprises an exemplary computing device display screen with an SMS message with a customized URL for accessing an odometer mileage extraction (OME) application as configured in accordance with various embodiments of the invention;

FIG. 3 comprises an exemplary device display screen of an OME application welcome screen as configured in accordance with various embodiments of the invention;

FIG. 4 comprises an exemplary computing device display screen of an OME application participation agreement request user interface as configured in accordance with various embodiments of the invention;

FIG. 5 comprises an exemplary computing device display screen of an OME application location access request user interface as configured in accordance with various embodiments of the invention;

FIG. 6 comprises an exemplary computing device display screen of an OME application photo-taking user interface in an initial stage as configured in accordance with various embodiments of the invention;

FIG. 7 comprises an exemplary computing device display screen of an OME application photo-taking user interface with a drop-down menu as configured in accordance with various embodiments of the invention;

FIG. 8 comprises an exemplary computing device display screen of an OME application photo-taking user interface with an image thumbnail as configured in accordance with various embodiments of the invention;

FIG. 9 comprises an exemplary computing device display screen of an OME application review and submit page as configured in accordance with various embodiments of the invention;

FIG. 10 comprises an exemplary computing device display screen of an OME application submission success screen as configured in accordance with various embodiments of the invention;

FIG. 11 comprises a schematic diagram for a cloud platform deployment of a system for odometer mileage extraction as configured in accordance with various embodiments of the invention;

FIG. 12 comprises a schematic diagram for a mobile deployment of a system for odometer mileage extraction as configured in accordance with various embodiments of the invention;

FIG. 13A comprises a first schematic diagram of a system pipeline for recognizing odometer mileage from an image of an odometer as configured in accordance with various embodiments of the invention;

FIG. 13B comprises a second schematic diagram of a system pipeline for recognizing odometer mileage from an image of an odometer as configured in accordance with various embodiments of the invention;

FIG. 14 comprises an exemplary Faster Region-Based Convolutional Neural Network (RCNN) machine learning model as configured in accordance with various embodiments of the invention;

FIG. 15 comprises a flowchart of an exemplary method for training a character recognition object detection model as configured in accordance with various embodiments of the invention;

FIG. 16 comprises graphical representations of exemplary odometer images with characters identified by the character recognition object detection model configured in accordance with various embodiments of the invention;

FIG. 17 comprises an exemplary graphical representation of the mileage identification process of the trained character recognition object detection model as configured in accordance with various embodiments of the invention;

FIG. 18 comprises an exemplary post-processing application algorithm as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Businesses regularly update customer-facing aspects in an effort to improve the user experience. Indeed, better and more efficient user experiences lead to improved satisfaction, which is considered one of the top differentiators that impact customer loyalty. Digitization and process automation allow service providers to offer effective and time-saving interactions to improve customer experience.

Previously, when customers requested certain policy quotes, they were required to submit a significant amount of information, typically in a specific format and in a certain timeframe and then had to wait for further instructions. Furthermore, to protect against fraud, the information submitted (such as odometer readings) often required human verification, such as by an agent or via another avenue.

Based on the teachings herein, the user experience can be more streamlined and customized. Indeed, users may now upload photographs that can be used for retrieving quick information about a vehicle from their phone to a web-based app, which can be analyzed in seconds. This helps providers give quick and accurate quotes. Further, by reducing human error and accelerating the information collection process, user interactions are typically smoother. The inventive systems and methods disclosed herein simplify and accelerate the prior approach by providing an odometer mileage collection system that quickly and accurately extracts the odometer mileage from an image supplied by the user.

In addition, to using odometer information for policy quotes or claims, some users leverage programs that provide policy discounts for those that drive below average, such as less than a certain distance over a given period of time. Further, previous programs that provided discounts for limited driving often used one or more sensors that needed to be installed in a vehicle or potentially human verification such as visual confirmation from an agent. These increased the cost of such programs. To avoid the costs associated with additional sensor hardware or human verification, these teachings leverage other hardware available to users including image capturing devices regularly used by users.

In addition, OCRs systems that were previously known in the art were designed to read characters from high quality pictures taken by scanners or a camera under good lighting conditions. They use image techniques that are very specific to document images. They are trained to recognize printed characters which are different from characters in other settings such as on a screen or an odometer display. This is a particular problem for odometer images as they often contain a large variation in color, intensity, font, and texture. Thus, prior OCRs systems do not work well for images from uncontrolled sources. VIN numbers are another type of vehicle information for which OCR methods have been applied VIN recognition is a significantly easier problem than odometer reading recognition since, for modern cars, the VIN number plates are standardized. A new solution for extracting mileage readings from odometer images is described herein which advantageously quickly extracts an odometer mileage from odometer images, even when there are huge variations in color, intensity, font, and texture, with high accuracy.

Generally speaking, pursuant to these various embodiments, disclosed herein are methods, systems, and apparatus for obtaining and leveraging odometer information. By one approach, the methods described herein can train an object detection model (such as, e.g., a region-based convolution neural network or an RCNN model) to identify characters of an odometer in an image, such as a photograph of a vehicle odometer. To that end, these teachings may include a pre-processing application receiving an initial image that depicts a vehicle odometer and then applying an augmentation to the initial image. In some approaches, the augmentation process is a step randomly selected from a pre-determined set of augmentations.

In use, the method also may leverage an object detection model that receives the augmented image and analyzes the augmented image (or runs the object detection model) to identify at least one odometer character region of the augmented image. In some approaches, an odometer character region is defined by coordinates of a portion of the augmented image bounding that odometer character region, for example, the coordinates of the perimeter. In some aspects, the object detection model may receive a training image comprising an initial image that has been previously annotated to identify at least one training odometer character region and the character inside that region, where each training odometer character region has defined coordinates for a portion of the initial image bounding one odometer character. Further, by some approaches, the object detection model is leveraged to compare the at least one odometer character region with the at least one training odometer character region.

In use, the steps of applying the augmentations to images and running the object detection model are typically repeated until a number of augmented images equal to a batch size have been run through the object detection model such that the object detection model is updated (such as by updating the model parameters of the object detection model) based on the various comparisons.

In some applications, these teachings can be leveraged to determine characters from an image of a vehicle odometer after receiving the input image at a trained character recognition object detection model, that is previously trained to identify characters in an image. By some approaches, the method outputs an odometer character region of an image and coordinates for each portion of the image bounding an odometer character region, by the trained character recognition object detection model. For example, for each odometer character region, a class label categorized as a distinct character 0-9 or any non-numeric character, and the class label probability for that region may be identified. In some embodiments, a post-processing application receives an analyzed or annotated image. For example, the trained character recognition object detection model may output or send the image along with coordinates, class label and class label probability for that each odometer character region of the image. Further, the method may determine, based on the coordinates for at least one odometer character region, and the probability and class label for each odometer character region, a series of characters (via the post-processing application and based on the image).

In some configurations, a system for determining characters of an odometer reading from an image includes one or more processors with non-transitory memory, a storage device, a trained character recognition object detection model, and a post-processing application. In one illustrative embodiment, the trained character recognition object detection model is configured to run on at least one of the at least one processor and is previously trained to receive an image including an odometer and in response output coordinates for a portion of the image bounding each odometer character region, and, for each odometer character region, a class label categorized as a distinct character 0-9 or any non-numeric character, and the class label probability for that region. In some approaches, the post-processing application is configured to run on at least one of the at least one processor after the trained character recognition object detection model has been run. In such a configuration, the system may be configured to receive an image, store the image, run the trained character recognition object detection model with the image as input, and output coordinates for each portion of the image bounding an odometer character region, by the trained character recognition object detection model. Further, for each odometer character region, a class label categorized as a distinct character 0-9 or any non-numeric character, and the class label probability for that region may be identified. In addition, the system may be configured to receive coordinates, class label and class label probability for each odometer character region of the image and determine, the probability and class label for each odometer character region, a series of characters.

The following description is not to be taken in a limiting sense, but is made merely for the purpose of describing the general principles of exemplary embodiments. The scope of the invention should be determined with reference to the claims.

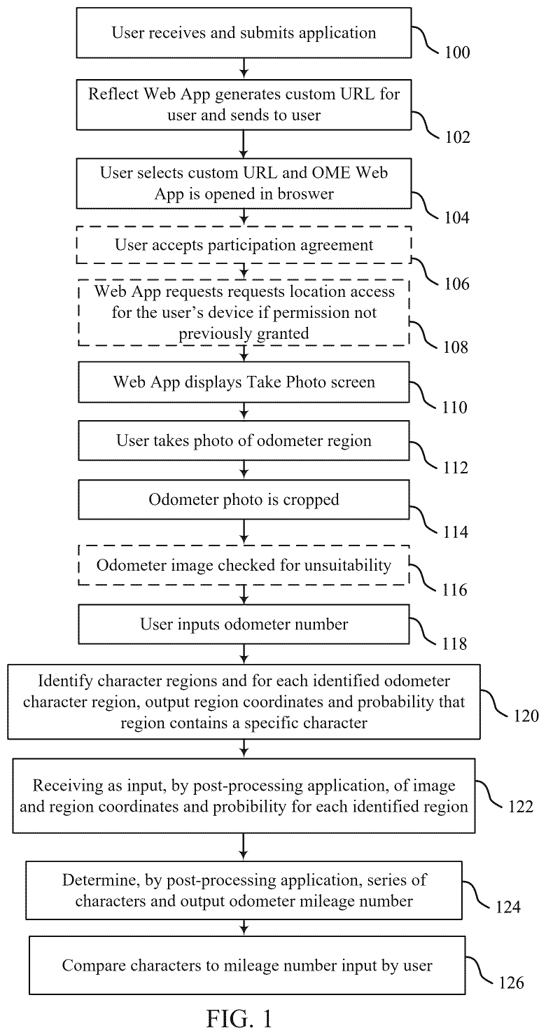

These and other benefits may become clearer upon making a thorough review and study of the following detailed description. Referring now to the drawings, and in particular to FIG. 1, a high-level process flow of a method for execution of a user application for odometer mileage extraction (OME) is shown.

In a first step 100, a user receives an invitation (or submits a query, request for a quote or an application) from an insurance agent. In some embodiments, the user receives the invitation when an insurance policy is sold/bound. The user submits the application to a back-end system.

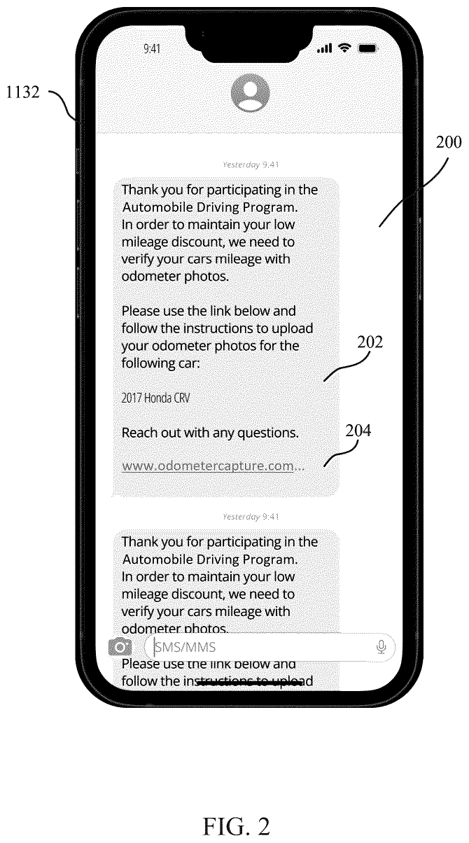

In a second step 102, a web APP or the back-end system generates a customized URL for the accessing the OME application based on the application and sends the customized URL to the user. In some embodiments, the URL is sent to the user via SMS. An exemplary computing device 1132 display screen 200 with an SMS message 202 with a customized URL 204 for accessing the OME application for this step is shown in FIG. 2.

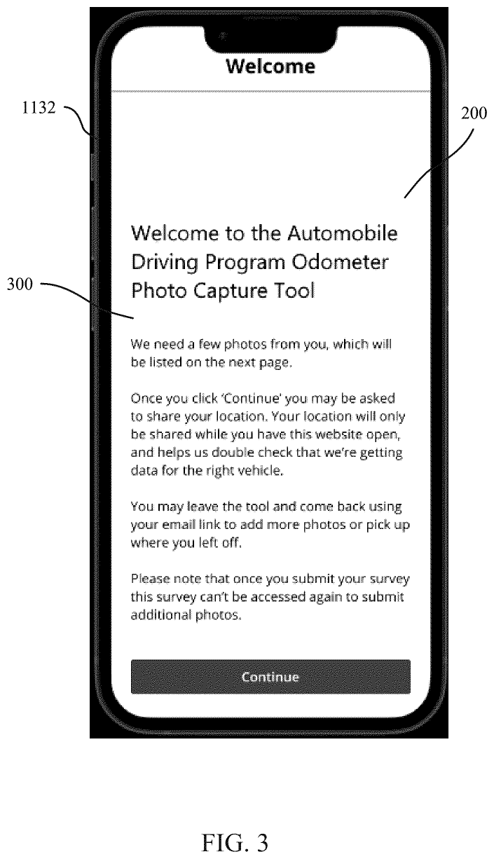

In a third step 104, the user selects the URL on their computing device and in response the OME application is opened on the user's computing device. An exemplary computing device 1132 display screen 200 with an OME application welcome screen 300 for this step is shown in FIG. 3.

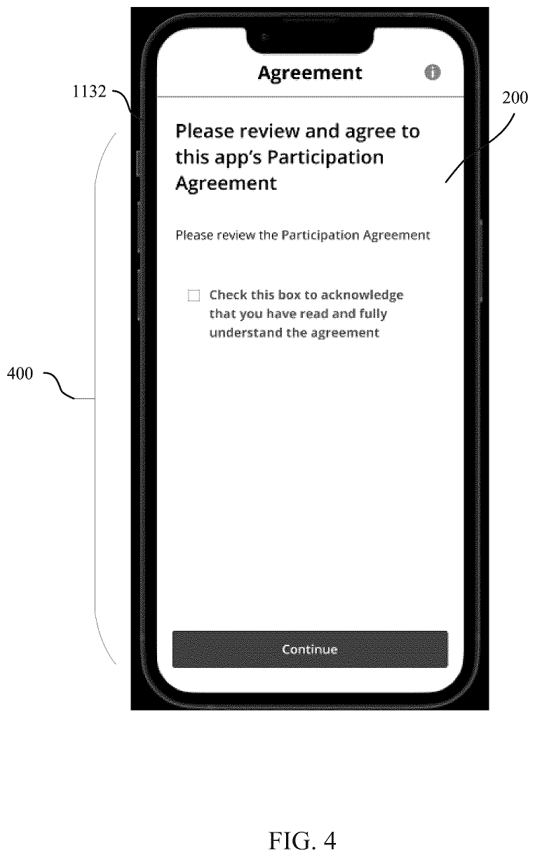

In a fourth optional step 106, the OME application solicits acceptance by the user of a participation agreement. If the user does not accept the participation agreement, the OME application exits at this step. An exemplary computing device 1132 display screen 200 with an OME application participation agreement request user interface 400 for this step is shown in FIG. 4.

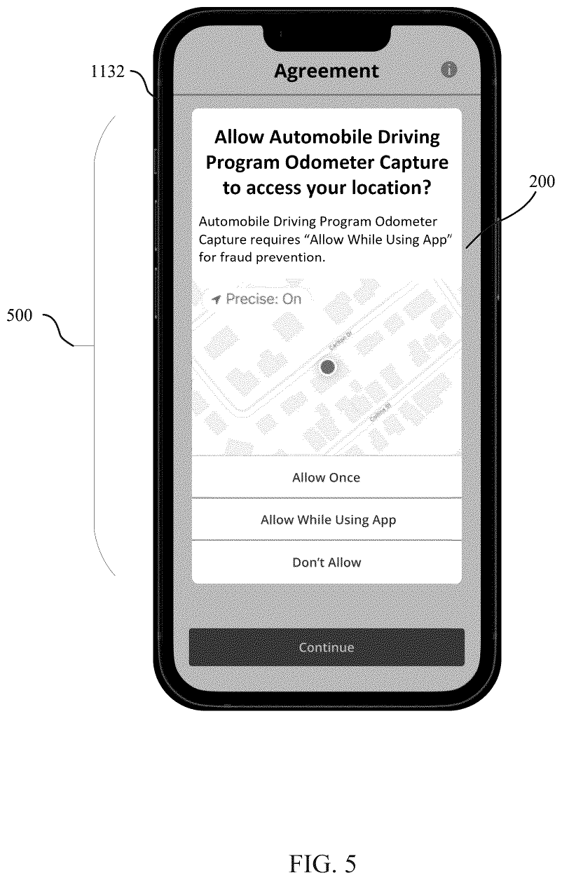

In a fifth step 108, if the OME does not have permission to access the location of the user's device, the OME requests location access for the user's device. If the user does not allow location access for the user's device, the OME application exits at this step. An exemplary computing device 1132 display screen 200 with an OME application location access request user interface 500 is shown. for this step is shown in FIG. 5.

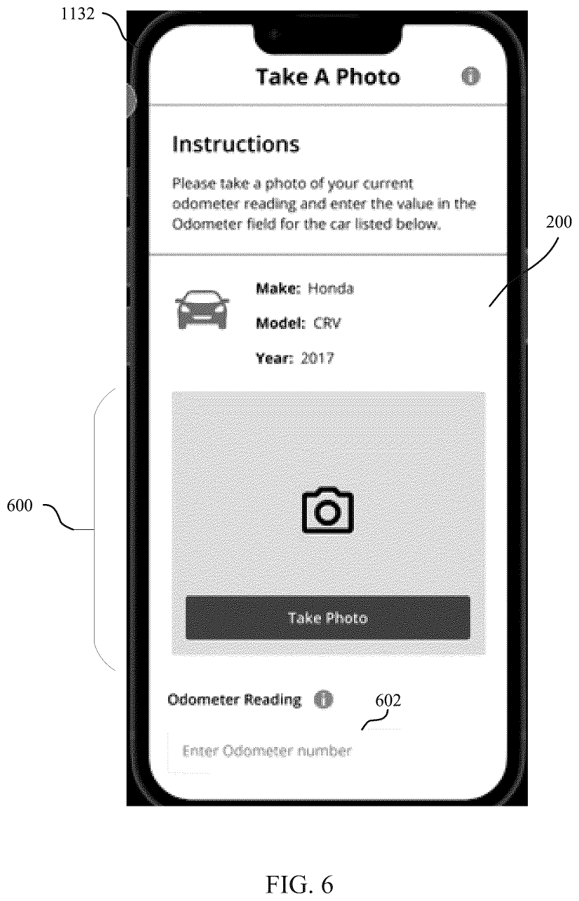

In a sixth step 110, the OME application displays to the user a user interface for taking a photo of the user's odometer reading. An exemplary computing device 1132 display screen 200 with the photo-taking user interface 600 for this step is shown in FIG. 6. An odometer number input user interface 602 is also shown.

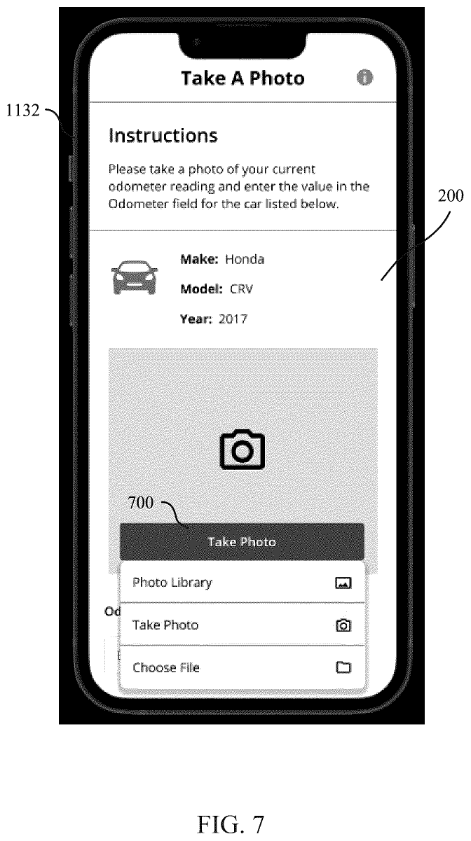

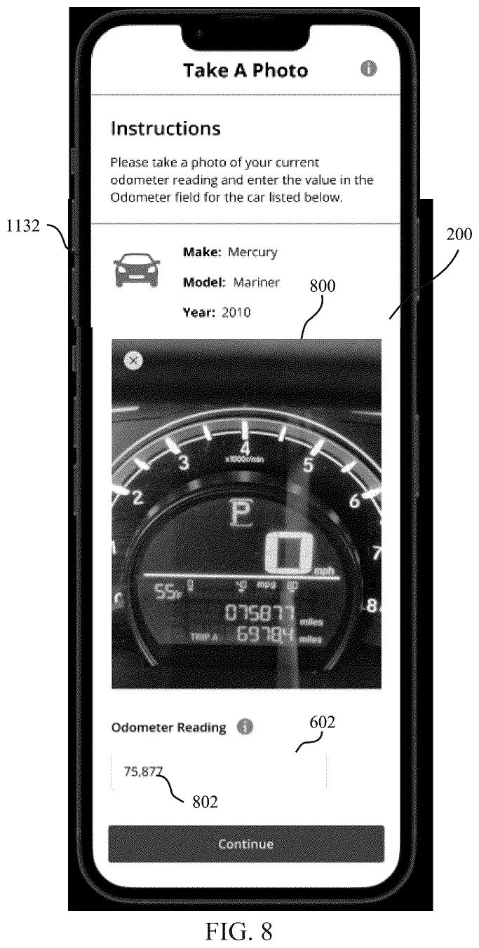

In a seventh step 112, the user takes a digital photograph (i.e. a digital image) of their vehicle using a camera of their computing device. In some embodiments, the photo is taken using the OME app. In other embodiments, the photo is taken using the camera application of the user's computing device. An exemplary computing device 1132 display screen 200 with a drop-down menu 700 for taking or selecting the photo from the user's photo library or a file saved on the computing device 1132 is shown in FIG. 7. An exemplary computing device 1132 display screen 200 showing a thumbnail 800 of the taken or selected image is shown in FIG. 8.

In some approaches, a guidance module may be used in conjunction with the camera to selectively capture the area of interest (i.e. the region of the vehicle interior containing only the odometer). In one example, the guidance module may process the captured image based on a bounding box that is overlaid with the live camera feed. The bounding box extents may be automatically determined or user selected. For example, the bounding box may be placed onto the screen or image during the capture operation and the screen may subsequently update, change, or progress to the next action once a user has properly placed the odometer within the bounding box. While some configurations may automatically progress from the image capture screen once the odometer is placed within the bounding box, other embodiments may require user confirmation before advancing the process.

In some embodiments, the user may take and submit a video (i.e. a sequence of frames) of the odometer. In other embodiments, the user streams video of the odometer to the OME application, and the OME selects a frame from the streamed video. Taking a frame from streaming video is advantageous as it will minimize the likelihood that a user uploads an old photo, and will allow the OME application to receive user input/correction as the user is in the system while the video is streaming, rather than having to ask for a follow-up later (e.g. if the image is not clear enough or we otherwise can't extract the mileage).

In the eighth step 114, in some approaches the OME application may crop the odometer photo to a cropped image after the camera has taken the photo of the area including the odometer. Generally, the odometer photo is cropped to reduce the image size while still retaining the portion of the image which contains the odometer. In some approaches the OME application may additionally check the photo taken in the previous step and crop the photo only if needed to reduce the image size and/or eliminate extraneous vehicle interior features shown in the photo. In some embodiments, a machine learning model is used to crop the odometer photo. In other embodiments, an algorithm is used to crop the photo, or any suitable application for cropping the photo may be used.

If a video is submitted, the OME application selects a frame of the video as the photo to be cropped.

In an optional ninth step 116, the OME application runs an algorithm to check for unsuitability of the cropped image (e.g. blurriness). If the cropped image is found to be unsuitable, the OME application displays a message stating that the photograph is unsuitable and the user is required to try again.

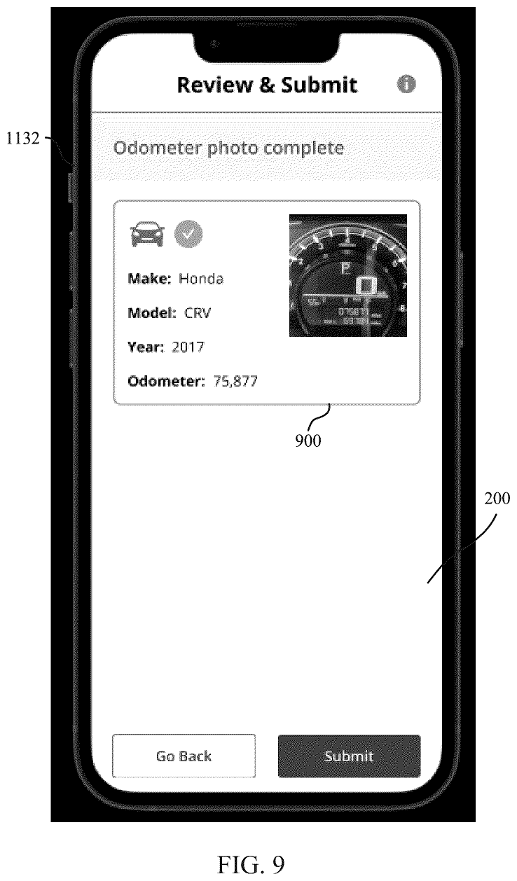

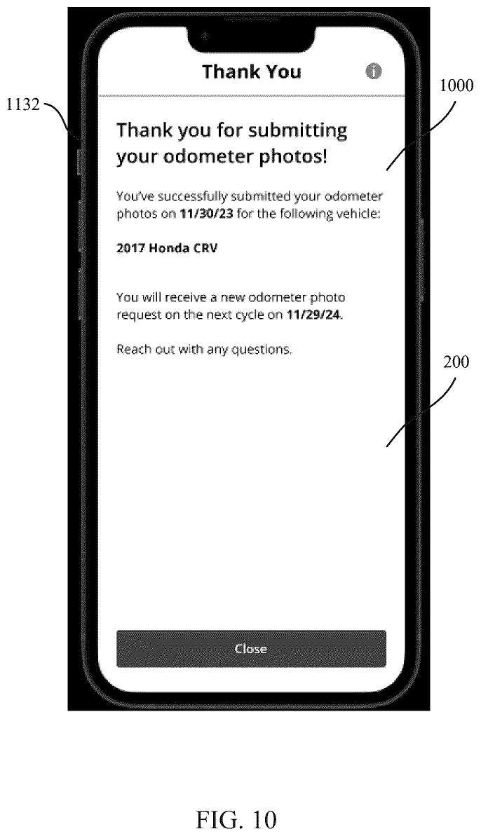

In a tenth step 118, the user manually inputs the vehicle's odometer number into the OME application and submits the cropped odometer image and number. The exemplary computing device 1132 display screen 200 showing the cropped odometer image 800, and odometer number input user interface 602 with input odometer number 802 is shown in FIG. 8. An exemplary computing device 1132 display screen 200 showing a review and submit page 900 summarizing the user's submission is shown in FIG. 9. An exemplary submission success screen 1000 is shown in FIG. 10.

In an eleventh step 120, a character recognition application receives the cropped odometer image and runs the cropped odometer image through a trained character recognition object detection model. The trained character recognition object detection model outputs a plurality of character regions and, for each character region, a recognized character and a probability for the character.

In a twelfth step 122, a post-processing application receives the output of the RCNN model and the cropped image.

In a thirteenth step 124, the post-processing application determines a series of characters and outputs the series of characters representing the recognized odometer reading (i.e. odometer mileage number).

In a fourteenth step 126, the OME application receives the series of characters and compares them to the odometer number submitted by the user. If the characters match and are a possible odometer number, an indication of success is given to the user via the application. If the characters do not match or they match but are not a possible odometer number, a failure indication is given to the user via the application.

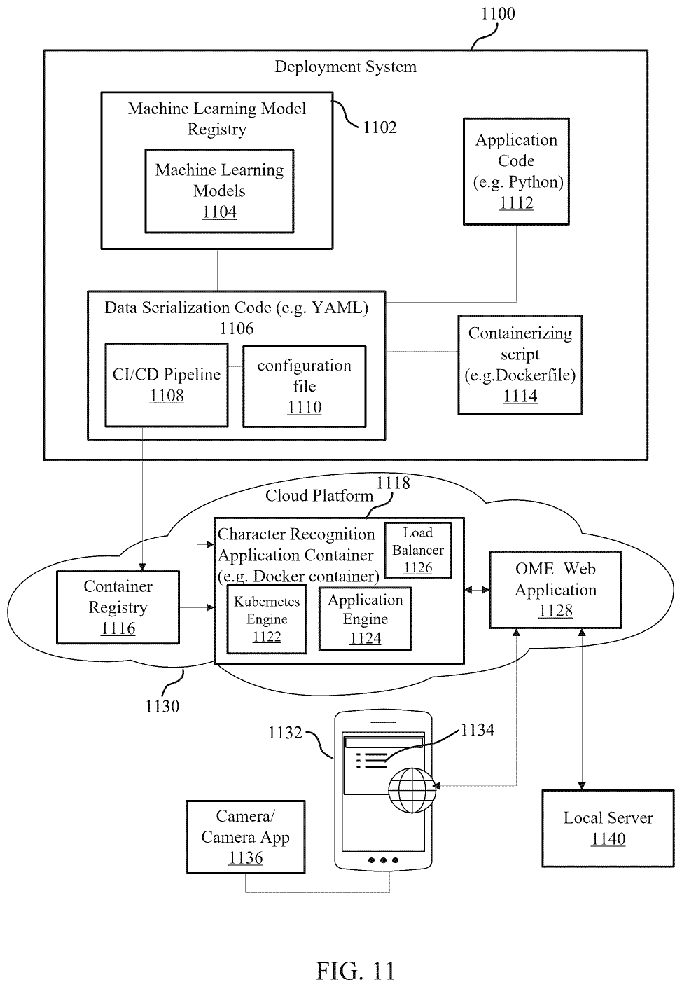

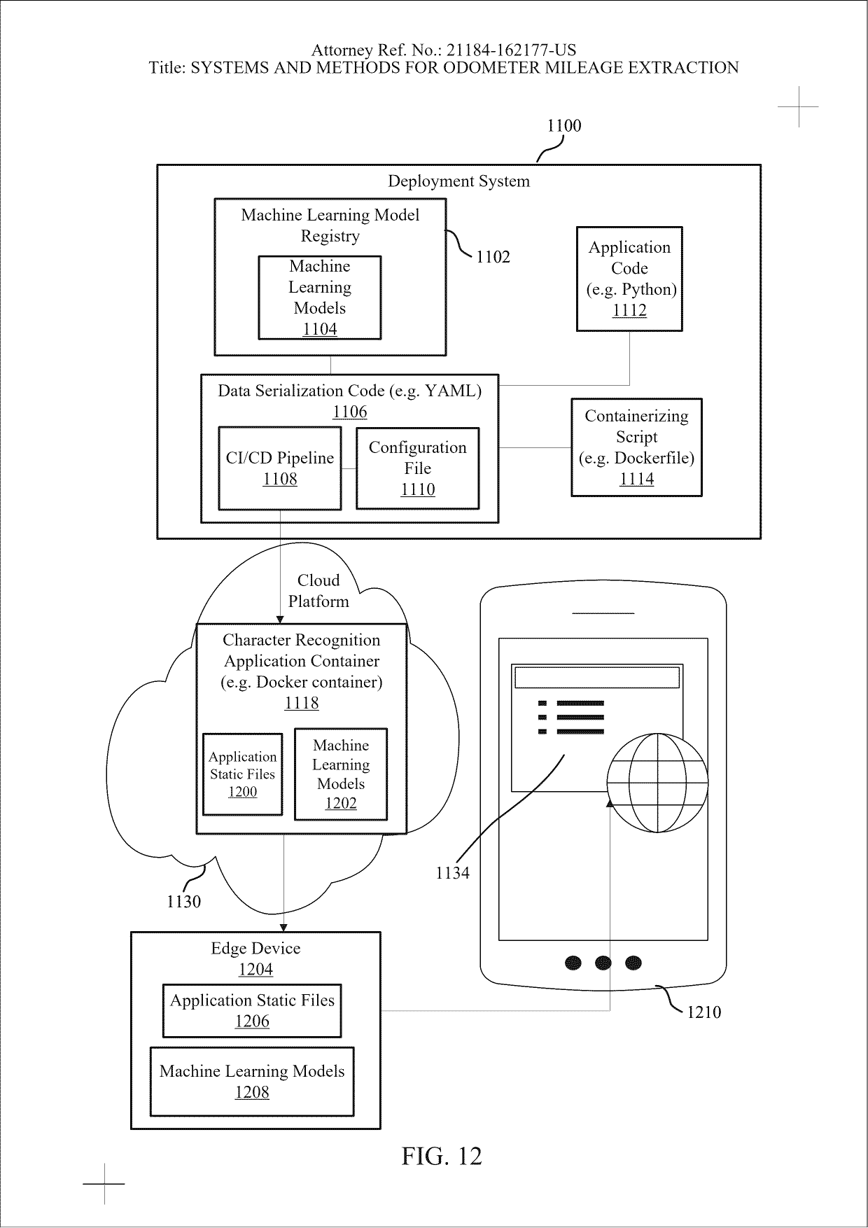

As suggested above, FIGS. 2-10 provide illustrative examples of the graphical user interface displayed on an end user computing device, such as computing device (mobile or desktop) 270, which also is shown in FIGS. 11 and 12.

Those skilled in the art will appreciate that the above-described processes are readily enabled using any of a wide variety of available and/or readily configured platforms, including partially or wholly programmable platforms as are known in the art or dedicated purpose platforms as may be desired for some applications.

Referring next to FIG. 11, an illustrative approach to such a platform will now be described. As shown, FIG. 11 is a schematic diagram for a cloud platform deployment of a system for odometer mileage extraction (OME).

In some illustrative embodiments, the deployment system 1100 comprises a code repository (e.g. GitLab repository) containing application (e.g. python) code 1112, containerizing script 1114 (e.g. Dockerfile), Data Serialization (e.g. YAML) code 1106, and a Machine Learning Model registry 1102 including one or more machine learning models 1104. In some approaches, the Data Serialization code 1106 includes a CI/CD pipeline 1108 and a configuration file 1110.

Containerized deployment is advantageous for being easily configurable, compatible to run on any operating system, and easily scaled to multiple machines. Additionally, microservices running inside containers typically provide isolation from actual system ingesting the service and provide flexibility to work independently and quickly. In some configurations, the character recognition application is deployed as a microservice running in a container. Containerized deployment packages codes and dependencies into an image that runs inside a container.

In some illustrative configurations, the deployment process works as follows: the CI/CD (i.e., continuous integration and continuous deployment) pipeline 1108 registers the machine learning models specified in the data serialization configuration file 1110. The CI/CD pipeline 1108 then builds the Character Recognition application container (Docker container) 1118 from the containerizing script with the prerequisite packages (e.g. application frameworks, models, modules, extensions, and/or tools)] and copies the machine learning models 1104 over to the container 1118. The containerized character recognition application is then typically deployed on a cloud platform 1130 (e.g. GCP CloudRun) using the CI/CD pipeline 1108. When deployed, the Character Recognition Application Container may include a load balancer I 1126, a Kubernetes engine 1122, and an application engine 1124. A container registry 1116 containing the localization model and the recognition model is also typically stored on the cloud platform. 1130

The odometer mileage extraction (OME) step or process may be a web application stored on and accessed via a cloud platform. The user's computing device generally accesses the web application using a web browser, though it is possible other access options, like an API, may be utilized in certain embodiments. The user's computing device includes a camera and camera application for taking digital photos and submitting them to the web application. The OME web application is also communicatively connected to the character recognition application container and to a local server.

Referring next to FIG. 12, a schematic diagram for a mobile deployment of a system for odometer mileage extraction (OME) is illustrated. Shown therein are deployment system 1100, which includes machine learning model registry 1102, application code 1112, data serialization code 1106, and containerizing script 1114. The machine learning model registry includes machine learning models 1104. The data serialization code 1106 includes the CI/CD Pipeline 1108 and the configuration file 1110. Also shown is cloud platform 1130 with character recognition application container 1118 deployed on the cloud platform 1130. The character recognition application container 1118 includes application static files 1200 and the machine learning models 1202. Also shown is an edge device 1204, which includes application static files 1206 and machine learning models 1208.

The system for determining characters of an odometer reading from an image including a vehicle odometer is deployed on a browser 1134 of a mobile computing device 1210. The deployment process is workable as follows: the CI/CD pipeline 1108 bundles the machine learning models with the application static files. The static files are packed into a container image for deployment. When the Edge Device 1204 accesses the system the model files 1202 and application static files 1204 are downloaded to the edge device 1204 and then loaded into the model runtime. In one embodiment, the code is in Javascript, and there is a CI/CD pipeline to register the model.

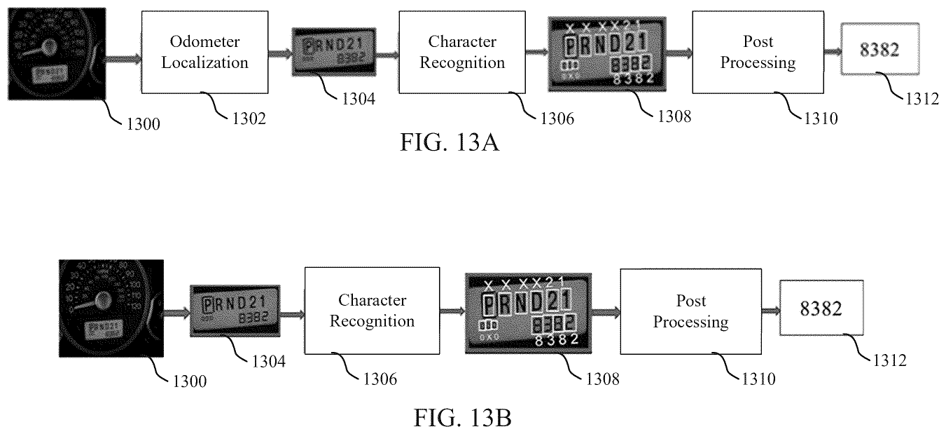

Referring next to FIG. 13A, a schematic diagram of a first system pipeline for recognizing odometer mileage from an image of an odometer is shown.

Initially, an image is captured by a user. Then, the image which typically includes an odometer therein, is received by an odometer localization module 1302. An exemplary image 1300 is shown in FIG. 13A. The odometer localization module 1302 may include a trained machine learning model, a module of a larger application (for example, an odometer mileage extraction web application as disclosed herein), or a stand-alone application.

By some approaches, the odometer localization module identifies coordinates for a portion of the image bounding an area including the odometer characters and identifies the odometer character area. In some embodiments a trained odometer localization machine learning model of the module outputs coordinates defining the odometer character area of the image. The module then uses the coordinates and the image to crop the image to the odometer character area. The image cropped to the odometer character area 1304 for the exemplary image 1300 is shown in FIG. 13A.

The cropped image 1304 is then received by the trained character recognition object detection machine learning model 1306. The trained character recognition object detection machine learning model 1306 identifies odometer character regions of the received image, wherein each odometer character region is defined by coordinates for a portion of the image bounding that odometer character region. Then, the trained character recognition object detection model 1306, for each odometer character region, determines a class label categorized as a distinct character 0-9 or any non-numeric character (i.e. eleven class labels), and the class label probability for that region. In the exemplary image of FIG. 13A, a graphic representation 1308 of the character region and specific characters of the model output is shown. The non-numeric character class label is indicated graphically by an “X”. For clarity, the probability outputs are not shown.

Further, the output 1308 of the trained character recognition object detection model 1306 is received by a post-processing application 1310. The post-processing application 1310 outputs a series of characters 1312 representing the odometer mileage of the image, as shown by the numeral “8382”, which represents the odometer mileage number extracted from the initial image 1300.

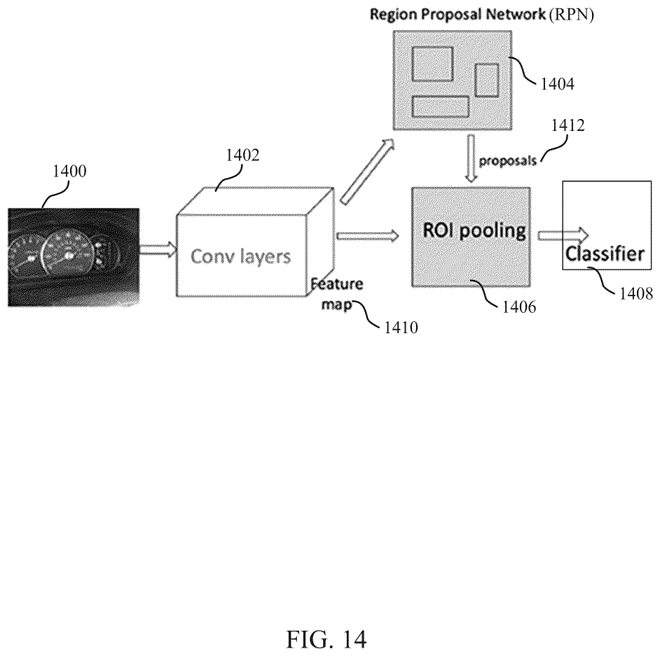

Referring next to FIG. 13B, a schematic diagram of a second system pipeline for recognizing odometer mileage from an image of an odometer is shown. The second system pipeline is typically used with an edge detection method, similar to that described above. The system pipeline of FIG. 13B is similar to the pipeline of FIG. 13A, except that the localization model step is removed in FIG. 13B. Referring next to FIG. 14, an exemplary machine learning model is shown in one embodiment of the present invention.

Those skilled in the art understand that machine learning comprises a branch of artificial intelligence. Machine learning typically employs learning algorithms such as Bayesian networks, decision trees, nearest-neighbor approaches, and so forth, and the process may operate in a supervised or unsupervised manner as desired.

Neural network systems are a type of machine leaning that can learn from data and perform various tasks, such as classification, regression, clustering, anomaly detection, natural language processing, computer vision, etc. Neural network systems typically comprise one or more layers of interconnected processing units, also known as neurons or nodes, that receive inputs, process them, and produce outputs. The outputs of one layer can serve as the inputs of another layer, forming a hierarchical structure. The processing units can have different activation functions that determine how the inputs are transformed into outputs. The processing units can also have different types of connections, such as feedforward, recurrent, or convolutional, that determine how the information flows through the network.

Neural network systems can be trained using various methods, such as supervised learning, unsupervised learning, reinforcement learning, etc. Training involves adjusting the parameters or weights of the processing units based on a learning algorithm and a loss function that measures the discrepancy between the actual outputs and the desired outputs. Training can be performed using various techniques, such as gradient descent, backpropagation, stochastic gradient descent, etc. Training can also involve regularization techniques that prevent overfitting or underfitting of the data, such as dropout, batch normalization, weight decay, etc.

Early object detectors used pyramidal sliding windows over the input image followed by an image classifier to detect objects at various location and scales. The RCNN framework made significant improvements over the early object detectors by using selective search for region proposals and convolutional feature maps as input. The subsequent framework Fast RCNN was significantly faster than the previous frameworks, but the region proposal technique was still too slow for most real-time applications. Faster RCNN solves this problem by using a different region proposal network. RCNN, Fast RCNN, and Faster-RCNN are all examples of two-stage (i.e. proposal) frameworks, where the first stage generates region proposals (potential bounding boxes), and the second stage classifies those regions into object categories and refines their bounding boxes.

In one embodiment of the present invention, the trained character recognition object detection model is a Faster RCNN model.

As illustrated in FIG. 14, Faster RCNN can be roughly viewed as a combination of two networks: The region proposal network (RPN) 1404 and a classifier 1406. The RPN 1404 takes convolutional feature map inputs and outputs a set of rectangular object proposals and an objectness score for each proposal. But before that, an earlier processing step is translating the input image 1400 to convolutional feature maps 1410 by passing the image 1400 through a series of convolution layers 1402. In faster RCNN, RPN is modeled with a fully convolutional network. Region proposals 1412 are generated by sliding a small sub-network over this convolutional feature map output 1410. The sub-network looks at n×n spatial windows of input feature maps and projects it into a lower dimensional feature vector. At the end of the sub-network architecture there are two sibling layers: a box-regression layer and a box-classification layer. The regression layer outputs delta coordinates to adjust the reference anchor coordinates for each spatial window. The box-classification layer predicts the possibility of an anchor box being either background or an object. For the next stage of processing, only the anchors with high scores are retained.

The second part of the faster RCNN architecture is a classifier 1408 that predicts the class label for the regions proposed by the RPN 1404. The classifier 1408 also contains a regression layer that outputs offset coordinates to further tighten the proposed box. The output region from the RPN is passed through a region of interest (ROI) pooling layer 1406 to map them to a fixed shape before feeding them to the classifier 1408. The classifier 1408 comprises of a fully connected layer that outputs Softmax (i.e. probability) scores across all the class labels.

In one embodiment, the Faster RCNN framework uses ResNet (Residual Network) architecture for the backbone. In some embodiments the ResNet architecture is ResNet 152 architecture. In other embodiments the ResNet architecture is Inception-ResNet, though other options may be employed.

In one embodiment, the Faster RCNN model uses DarkNet architecture, though other options may be leveraged.

In another embodiment of the present invention, a YOLO (You Only Look Once) framework is used. YOLO is specifically designed for real-time object detection tasks.

In a YOLO framework, a single CNN simultaneously predicts multiple bounding boxes and class probabilities for those boxes. The network is trained end-to-end to optimize this combined prediction task. This approach (one-stage/proposal-free) is different from methods like Faster R-CNN, which apply a separate model for proposing regions and another model for detecting objects (two-stage/proposal approach).

Generally, the YOLO framework is known for its speed, making it suitable for real-time object detection. An example of backbone architectures used for YOLO frameworks include DarkNet.

Other one-stage frameworks may be used. For example, the EfficientDet framework may be used. EfficientDet may use EfficientNet as the backbone architecture. EfficientDet provides high accuracy while being relatively small and less computationally intensive.

Other suitable one-stage or two-stage frameworks and backbone architectures may also be used.

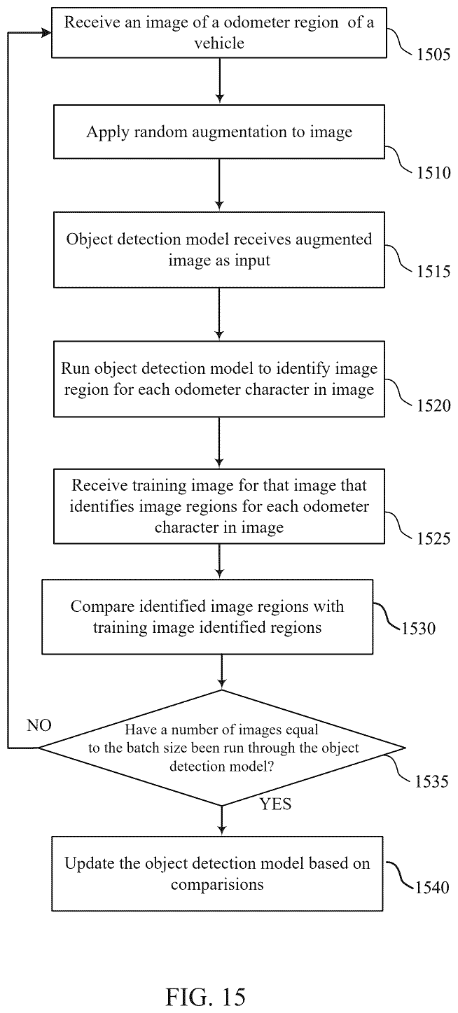

Referring next to FIG. 15, a flowchart of an exemplary method for training a character recognition object detection model is shown.

At step 1505, a pre-processing application receives an initial image of an odometer region of a vehicle. In some embodiments, the received image is a portion of a larger image of the dashboard of the vehicle that was previously cropped to the odometer region. In some embodiments the pre-processing application is connected to a network and the receiving of the initial image further comprises receiving the initial image via the network.

At step 1510, the pre-processing application applies an augmentation to the initial image, wherein the augmentation is randomly selected from a pre-determined set of augmentations. The determined set of augmentations may include changing a brightness of the initial image, changing a saturation, scaling the initial image, and changing a contrast of the initial image. By one approach, a combination of multiple augmentations is employed, which typically provides a significant increase in accuracy. These augmentations in the training set can account for different image sizes, brightness, quality, etc in the testing set.

At step 1515, the object detection model receives the augmented image as input.

At step 1520, the object detection model is run to identify at least one odometer character region of the augmented image, wherein each odometer character region is defined by coordinates for a portion of the augmented image bounding that odometer character region.

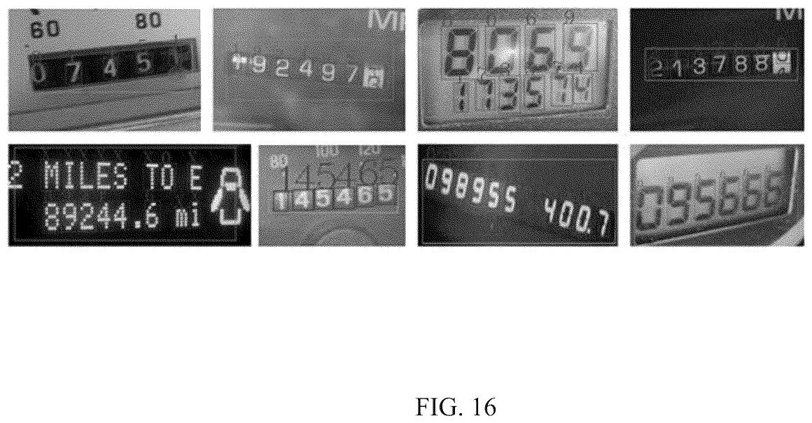

At step 1525, a training image is received comprising the initial image previously annotated to identify at least one training odometer character region and the character inside that region, each training odometer character region defining coordinates for one portion of the initial image bounding one odometer character. Graphical representations of exemplary odometer images with character region extents and characters identified by the character recognition object detection model are shown in FIG. 16.

At step 1530, the object detection model compares the at least one odometer character region with the at least one training odometer character region.

At step 1535, the method checks if a number of images equal to the batch size been run through the object detection model. If the number of images run through the model is less than the batch size, the method returns to step 1505. If the number is equal to the batch size, the method proceeds to step 1540.

At step 1540, based on the comparisons, the object detection model updates at least one model parameter of the object detection model.

The method of FIG. 15 may be repeated for a number of batches. In some embodiments, a learning rate of the object detection model is variable over the number of batches.

In some embodiments, the learning rate is initially a constant first value, increases to a second larger value after a first point, and decreases after a second point. In one embodiment the learning rate is initially 0.009, increases to 0.015 after a first point, and decreases after a second point. A large learning rate can lead the model to diverge, so a warmup period is used during which the learning rate increases to its initial maximum. The learning rate will decrease after that so the model will gradually take smaller steps in order to reach the optimal point of convergence. If the model maintains the larger learning rate, the model might miss the optimal point of convergence.

In some embodiments, the batch size is 32. In other embodiments, the batch size is 16 or 8.

In some embodiments, a grid anchor generator is used with scales of 0.25, 0.5, 1.0, and 2.0, aspect ratios of 0.5, 1.0, and 2.0 and strides of 8 for both height and width, resulting in a total of 12 proposal boxes for each anchor position in the grid. In some embodiments, the post-processing application is set to reject all the detections with score <0.4 (i.e. rejection threshold of 0.4). In other embodiments, the rejection threshold may set at 0.35 or 0.3. The threshold, there are 100 total bounding boxes detected. They have a confidence score that is the % confidence that the bounding box contains a certain number. In some embodiments the Intersection Over Union (IOU) threshold is set to 0.6 for Non maximum suppression. The loss being minimized is the sum of localization loss and classification loss. In some embodiments, the localization loss and classification loss have different weights. In some embodiments the localization loss and classification loss are equally weighted.

By some approaches, he number of training steps may be 20,000. In other embodiments, the number of steps may be 15,000 or 50,000.

In one test set of these systems and methods, an odometer reading accuracy of 88.8% within an error boundary of 1,000 miles was obtained.

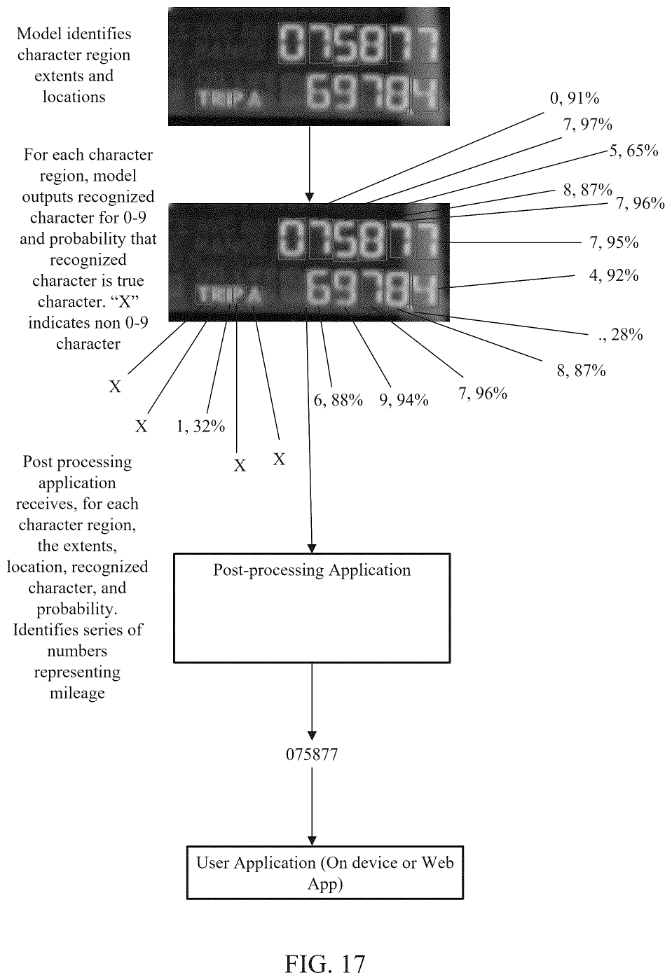

Referring next to FIG. 17, an exemplary graphical representation of the mileage identification process of the trained character recognition object detection model and post-processing application is shown.

First, the model identifies each character region and the character region extents and locations (i.e. the bounding box size and location for each character region).

Next, for each character region, the model determines a recognized character and applies the appropriate class label (as one of the characters 0-9, or a class label for all non-numeric characters). The model also determines a probability for each recognized numeric character. Graphical representations of exemplary odometer images with character region extents and characters identified by the character recognition object detection model are shown in FIG. 16.

The post-processing application receives, for each character region, the image, the coordinates for each odometer character region, and the probability and class label for each odometer character region, and outputs a series of characters representing the recognized mileage of the odometer.

A user application receives the mileage number. The user application may be a desktop application, a mobile application, a web application, or any other suitable type of application.

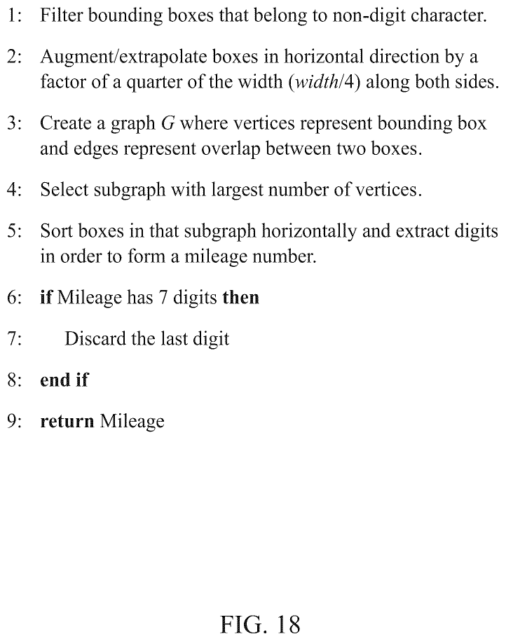

Referring next to FIG. 18, an exemplary post-processing application algorithm is shown.

As suggested above, the character recognition objection detection model identifies individual characters inside the odometer display along with their coordinates. In the last part of the process, the digits that are part of the mileage reading are isolated. The post-processing step combines nearby characters to form words/numbers and selects the most likely number as the mileage reading. In some digital odometers, additional information is displayed alongside the mileage reading. Some of the most frequently seen additional pieces of information include temperature, time, warning messages, trip meter reading, fuel status, etc. It is essential to distinguish the actual mileage reading from other numbers being displayed on the screen. Similarly, for an analog odometer there are generally two variants: most models have six digits, while a few older models have 7 digits. Usually, the 7th digit changes every 1/10th of a mile and is not considered a significant part of the mileage reading.

An algorithm of the post-processing application takes these parameters into account and determines the odometer mileage number from the recognized characters.

First, the algorithm filters out bounding boxes for non-digit characters.

Second, the algorithm augments each remaining box in the horizontal direction.

Third, the algorithm creates a graph where vertices represent bounding boxes and edges represent overlaps between bounding boxes.

Fourth, the subgraph with the largest number of vertices is selected.

Fifth, the bounding boxes of that subgraph are sorted horizontally and digits are extracted to form a number (i.e. the number representing the mileage).

In the last steps, the algorithm checks if the number has seven digits and if so, discards the last digit. The algorithm then returns the final number as the mileage number.

In some embodiments, the post-processing application is set to reject all the detections with score of about <0.4 (i.e. rejection threshold of about 0.4). In other embodiments, the rejection threshold may set at about 0.35 or 0.3. In some embodiments the Intersection Over Union (IOU) threshold is set to about 0.6 for Non maximum suppression. The loss being minimized is the sum of localization loss and classification loss. In some embodiments, the localization loss and classification loss have different weights. In some embodiments the localization loss and classification loss are equally weighted.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

While the invention herein disclosed has been described by means of specific embodiments, examples and applications thereof, numerous modifications and variations could be made thereto by those skilled in the art without departing from the scope of the invention set forth in the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A method for training a neural network object detection model to identify characters of an odometer in an image that includes a vehicle odometer, comprising:
receiving, by a pre-processing application running on at least one processor, an initial image that includes an image of a vehicle odometer;
applying, by the pre-processing application, an augmentation to the initial image, wherein the augmentation is randomly selected from a pre-determined set of augmentations;
receiving, by the object detection model, of the augmented image as input to the object detection model;
in response to receiving the augmented image, running the object detection model to identify at least one odometer character region of the augmented image, wherein each odometer character region is defined by coordinates for a portion of the augmented image bounding that odometer character region;
receiving, by the object detection model, a training image comprising the initial image previously annotated to identify at least one training odometer character region and the character inside that region, each training odometer character region defining coordinates for one portion of the initial image bounding one odometer character;
comparing, by the object detection model, the at least one odometer character region with the at least one training odometer character region;
repeating previous steps until a number of augmented images equal to a batch size have been run through the object detection model; and
based on the comparisons, updating, by the object detection model, at least one model parameter of the object detection model.

2. The method of claim 1, wherein the running the object detection model further comprises identifying, for each odometer character region, an individual character inside the odometer character region.

3. The method of claim 2, further comprising:
comparing, by the object detection model, the at least one odometer character region and the identified character inside that odometer character region with the at least one training odometer character region and the character inside that training odometer character region.

4. The method of claim 1, wherein the pre-determined set of augmentations includes changing a brightness of the initial image, changing a saturation, scaling the initial image, and changing a contrast of the initial image.

5. The method of claim 1, wherein the object detection model is a convolutional neural network model.

6. The method of claim 5, wherein the convolutional neural network model is a single-shot object detection neural network model.

7. The method of claim 1, wherein the batch size is 32.

8. The method of claim 1, further comprising repeating the previous steps for a number of batches.

9. The method of claim 8, wherein a learning rate of the object detection model is variable over the number of batches.

10. The method of claim 9, wherein the learning rate is initially a constant first value, increases to a second larger value after a first point, and decreases after a second point.

11. The method of claim 9, wherein the learning rate is initially 0.009, increases to 0.015 after a first point, and decreases after a second point.

12. The method of claim 1, wherein the pre-processing application is connected to a network and the receiving of the initial image further comprises receiving the initial image via the network.

13. The method of claim 1, wherein a number of steps for a recognizer of the object detection model is 5700.

14. A method for determining characters from an image including a vehicle odometer, comprising:
receiving the image as input by a trained character recognition object detection model, wherein the character recognition object detection model is running on at least one of at least one processor and is previously trained to identify characters in an image;
outputting by the trained character recognition object detection model of at least one odometer character region of the image, wherein each odometer character region is defined by coordinates for a portion of the image bounding that odometer character region;
outputting by the trained character recognition object detection model, coordinates for each portion of the image bounding an odometer character region, and, for each odometer character region, a class label categorized as a distinct character 0-9 or any non-numeric character, and the class label probability for that region;
receiving, from the trained character recognition object detection model, by a post-processing application running on at least one of the at least processor, of the image and, for each odometer character region, coordinates, class label and class label probability for that odometer character region of the image; and
determining, by the post-processing application, based on the image, the coordinates for at least one odometer character region, and the probability and class label for each odometer character region, a series of characters.

15. The method for determining characters of claim 14, wherein at least one processor is part of a mobile computing device.

16. The method for determining characters of claim 14, wherein the image is a frame extracted from a sequence of frames.

17. The method for determining characters of claim 14, wherein the series of characters represents an odometer mileage value.

18. The method for determining characters of claim 14, further comprising:
prior to receiving the image as input, for each of at least one pre-determined image criteria, determining whether the image satisfies the pre-determined image criteria; and
upon determining that the image satisfies each pre-determined image criteria, proceeding to the next step of the method.

19. A system for determining characters of an odometer reading from an image including a vehicle odometer, comprising:
at least one processor, wherein each processor comprises non-transitory memory;
a storage device;
a trained character recognition object detection model configured to run on at least one of the at least one processor, wherein the trained character recognition object detection model is previously trained to receive an image including an odometer and in response output coordinates for a portion of the image bounding each odometer character region, and, for each odometer character region, a class label categorized as a distinct character 0-9 or any non-numeric character, and the class label probability for that region; and
a post-processing application configured to run on at least one of the at least one processor after the trained character recognition object detection model has been run;
wherein the system is configured to perform the steps of:
receiving, by the storage device, of the image;
storing, by the storage device, of the image;
receiving, by the trained character recognition object detection model, of the image;
running the trained character recognition object detection model with the image as input;
outputting, by the trained character recognition object detection model, coordinates for each portion of the image bounding an odometer character region, and, for each odometer character region, a class label categorized as a distinct character 0-9 or any non-numeric character, and a class label probability for the associated region;
receiving, by the post-processing application from the trained character recognition object detection model, the image and, for each odometer character region, coordinates, class label, and class label probability for the associated odometer character region of the image; and
determining, by the post-processing application, based on the image, the coordinates for at least one odometer character region, and the probability and class label for each odometer character region, a series of characters.

20. The system for determining characters of an odometer reading of claim 19, wherein the image is a frame extracted from a sequence of frames.

21. The system for determining characters of an odometer reading of claim 19, wherein the series of characters represents an odometer reading.
